(19) United States
(12) Patent Application Publication
(10) Pub. No.: US 2008/0148575 A1
(43) Pub. Date: Jun. 26, 2008

(54) Created spoon-fork and spoon-knife

(76) Inventor: Jack Sing-Chiow Chan, Sugar Land, TX (US)

Correspondence Address: JACK CHAN Sing-Chiow, 11830 Pedernales Falls Ln, Sugar Land, TX, 77478, US

(21) Appl. No.: 11/644,160

(22) Filed: Dec. 22, 2006

(51) Int. Cl. A47J 43/28

(52) U.S. Cl. 30/150

(57) ABSTRACT

An invented spoon-fork and spoon-knife flatware are created with a shallow bowl of spoon in oval shape or other appropriate shapes denting into the new designed fork or created knife in metal or plastic materials and become dual functions of a new set of flatware.

### I FIELD OF INVENTION

The present invention is related to providing dual functions of forks and dual functions of table knifes as a solution to the existing problems for convenience of the diners.

### II BACKGROUND OF INVENTION

The creative design of the spoon-fork flatware was inspired when the inventor was having a package lunch containing beef, vegetables, and rice at a food store last year. The package box of lunch was provided with paper napkin and a plastic fork. The fork for piercing the beef and vegetable was appropriate and easy to manage, but using the fork to scope rice was awful as the rice was dropping and dropping. It was quite embarrassing as scooping rice is an appropriate function of a spoon. There was no plastic spoon available even requesting for one. In practice there was only fork provided. The inventor also experienced in other restaurants; only table fork and knife were provided for a combo plate of grilled fish with spiced rice, peas, and onions. The guests were expecting to scope the rice and peas with the fork. Obviously, the fork could not hold and thus depicting awful table manners. The table spoon would be provided only on requests. Therefore the inventor was immediately inspired to invent a flatware, a fork in combination of a spoon as a solution to this problem. There are a few patterns with variations of this invention which will be described in the next chapter.

Another innovative creation is a table knife created with a shallow bowl of teaspoon shape dented into the front edge of the table knife enables it to have an additional function of a spoon. This created knife with dual functions, a function of a knife and a function of a spoon is termed as a spoon-knife. In many occasions, a steak dinner served with peas, corn, and baked potatoes or rice, again only table fork and table knife were provided in the table set. Normally, people use fork to hold the steak and use knife to cut or slice the steak and then pierce with the fork to eat. That is the fashion. To use fork or knife to take rice or scope the baked or mashed potatoes is awful and irritating. Most of the dinning guests bear with it but some might request for a table spoon.

If the steak dinner was provided with a table set of napkin with fork and an invented spoon-knife which is created with dual functions could be used to scope rice, peas, corn, and potatoes. Then it would be a different story.

### III DESCRIPTION OF DRAWINGS

The descriptions pertaining to the drawings are as follows:

FIG. 1 depicts an innovative design of a spoon-fork for dual functions by adopting the concept and technology in putting an oval shape teaspoon dented into a small fork as indicated (2). Part of the length of the piercing grills (1) of the four pronged fork is replaced by the denting spoon. Extending upwards indicated (3) is the handle of this spoon-fork.

FIG. 1A provides a focus view on the created spoon-fork.

FIG. 2 shows the top view of the invented teaspoon-fork (2) in oval shape with the length of the piercing grills (1) adjusted and part of the length replaced by the bowl (2) of the created spoon with handle (3) indicated.

FIG. 3 shows the side view of the invented small spoon-fork with prongs (1), spoon (2), and the handle (3) indicated.

FIG. 4 is an innovative design of a table spoon-fork in oval shape denting into a table fork for dual functions and part of the length of the piercing grills (4) is replaced by the dented spoon (5). Extending upward is the handle (6) of the spoon-fork.

FIG. 4A provides a focus view on the prongs and the created spoon.

FIG. 5 shows a top view of the invented table spoon-fork in oval shape (5) with the adjusted length of the piercing grills (4). The handle of this table spoon-fork is indicated (6).

FIG. 6 depicts a side view of the invented table spoon-fork. The created spoon (5) and (5a) indicating that the depth of the spoon could be dented further if desired.

FIG. 7 depicts a created table spoon-fork with spoon (10), handle (6), and two jetting out piercing grills (9) for firm holding of food.

FIG. 7A provides a clear view of the invented table spoon-fork with two piercing grills jetting out.

FIG. 8 shows a top view of the table spoon-fork with spoon (10) and the grills (9) with the handle (6) indicated.

FIG. 9 shows the side view of the table spoon-fork with the spoon (10), the prongs (9), and the extensible depth (10a) of the spoon.

FIG. 10 shows a spoon-fork (12) is created with the arranging of the four piercing grills (11) in the curve as indicated at the focus view in FIG. 10A that the shape would appear like an oval shape shovel.

FIG. 10A provides a focus view on the curve shape prongs.

FIG. 10B shows how the curve arrangement of the four piercing grills is created with 35° between 1° and 90°. The curve line could also be created with 20° or 45° at discretion.

FIG. 11 shows the side view of the created spoon-fork with spoon (12), extensible depth (12a) and the piercing grills (11).

FIG. 12 shows a top view of the table spoon-fork (12) in oval shape could be made in line with the curvature of the four piercing grills (11) making the shape of the spoon-fork like a shovel.

FIG. 13 shows a top view of a small spoon-fork in oval shape (14) created in line with the curvature of the four piercing grills (13).

FIG. 14 depicts the full view of a table spoon-fork (12) with handle (6) created in line with the curvature of the four piercing grills (11) and the appearance this table spoon-fork like a shape of shovel as a variation pattern.

FIG. 15 shows the full view of a tea spoon-fork (14) with handle (3) and the four piercing grills (13) in curvature as a variation for choice of the users.

FIG. 16 depicts a table spoon-fork is created from a table fork with original fork (15) and the raised enclosure (16) and the created spoon (17) with the original prongs (4). The handle is indicated (6) therein.

FIG. 17 indicates the side view of the created side enclosure (16) for the spoon-fork from a table fork (15) with prongs (4).

FIG. 18 shows a top view of the created spoon-fork with one right side enclosure (16) and the spoon (17) from a table fork (15) with prongs (4) indicated.

FIG. 19 depicts a small spoon-fork is created with one right side enclosure (16a) and spoon (17a) from a cake fork (15a) with two jetting out piercing grills (7) for firm holding of foods.

FIG. 20 shows a top view of the created spoon-fork with one side left enclosure (16a) and spoon (17a) from a small fork (15a) with prongs (7) indicated. This replica with the enclosure at the left is for the use of the left handed diners.

FIG. 21 depicts another table spoon-fork is created with one right side spoon enclosure (16b) and the spoon (17b) from a table fork (15b) with prongs (9) indicated. The replica with the enclosure at the left is for the use of the left handed diners.

FIG. 22 shows a top view of the dented spoon (19) from a table fork (18) with prongs (4a) with three piercing grills in which the central grill in line or jetting out as indicated in dotting line is a pattern variation. This variation also applicable to FIG. 2, FIG. 5, FIG. 17 and FIG. 18 and also appropriate to others at discretion.

FIG. 23 shows the variation of the three piercing grills is also applicable to FIG. 14 and FIG. 15.

FIG. 24 depicts a side view of the created spoon-fork (19) is dented into the center spacing of the fork (18) with prongs (4) indicated.

FIG. 25 depicts the created table spoon-knife with a shape of teaspoon bowl (20) denting into the edge of the table knife providing a function of a spoon. Thus the table spoon knife (21) is created with the knife edge (22) and the handle (23) with the dented spoon bowl (20) for dual functions, the function of table knife and the function of a spoon when required. The U.S. Pat. No. 33,285 of Ames issued on Sep. 17, 1861 when using an on original knife joined with spoon-fork on the edge top of the knife. The appearance is awful and not convenience in using.

FIG. 26 shows a top view of the created spoon-knife (21) with handle (23) and the spoon bowl (20) dented in the right side of the knife. (appears left side in the drawing)

FIG. 27 shows a top view of the created spoon-knife (21) with handle (23) and the spoon bowl (20) dented in the left side of the knife. (appears right side in the drawing)

FIG. 28 depicts an elevation view of the invented spoon-knife (21) with the knife edge (22), handle (23), and the dented spoon bowl (20) at the right side. It is for the right handed diners to use at their convenience. The U.S. Pat. No. 843,953 of G. Laramy issued on Feb. 12, 1907 depicted a 3-combined function of a spoon-fork and knife. The knife is a steel blade which is so sharp that could be harmful, especially to children. Similarly, U.S. Pat. No. 4,771,544, U.S. Pat. No. 2,473,288 of A. G. Moneill and U.S. Pat. No. Des 190,198 of Arthur L. Kuhlman carry the same disadvantages.

FIG. 29 depicts an elevation view of the invented spoon-knife (21) with the knife edge (22), handle (23), and the dented spoon bowl (20) at the left side. It is a replica designed for the use of the left handed diners. The U.S. Pat. Des 192,970 of Albert Fredrick Loertz, Jr issued on Jun. 5, 1962 is a combination of knife, fork and spoon. The blade edge could cut the lip of the user. It imposes a risk to children even adult, if they were not careful. In comparison, the present invention, spoon-knife is a safety flatware with aesthetic value.

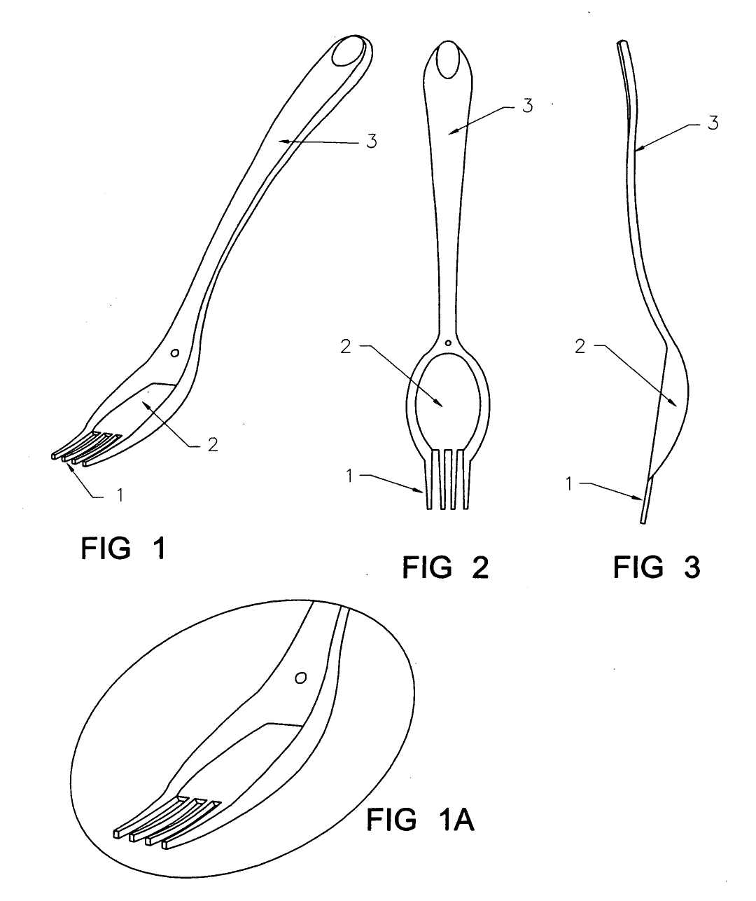

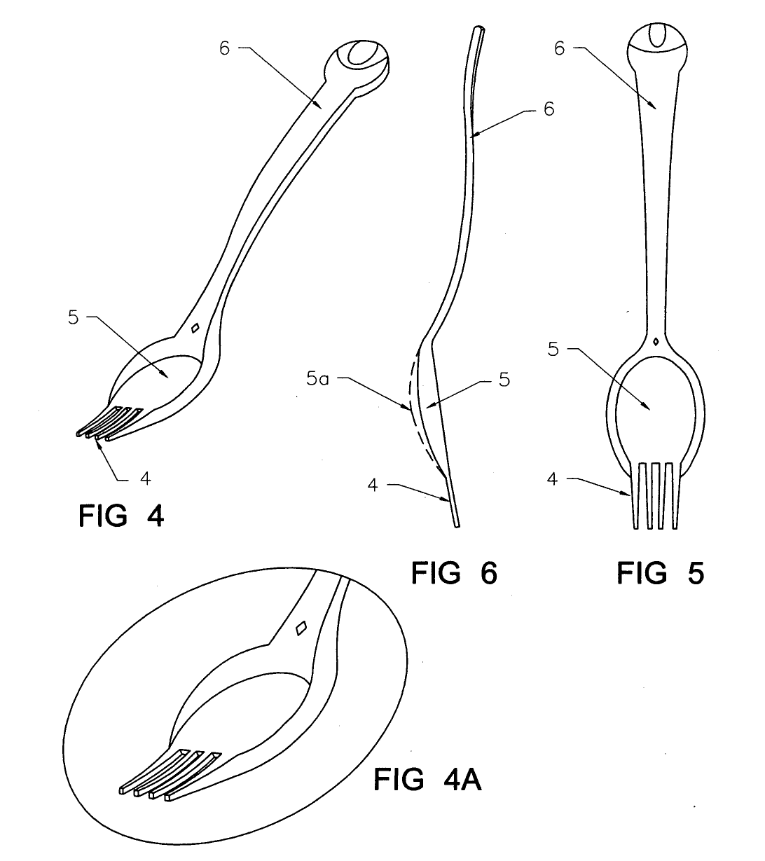

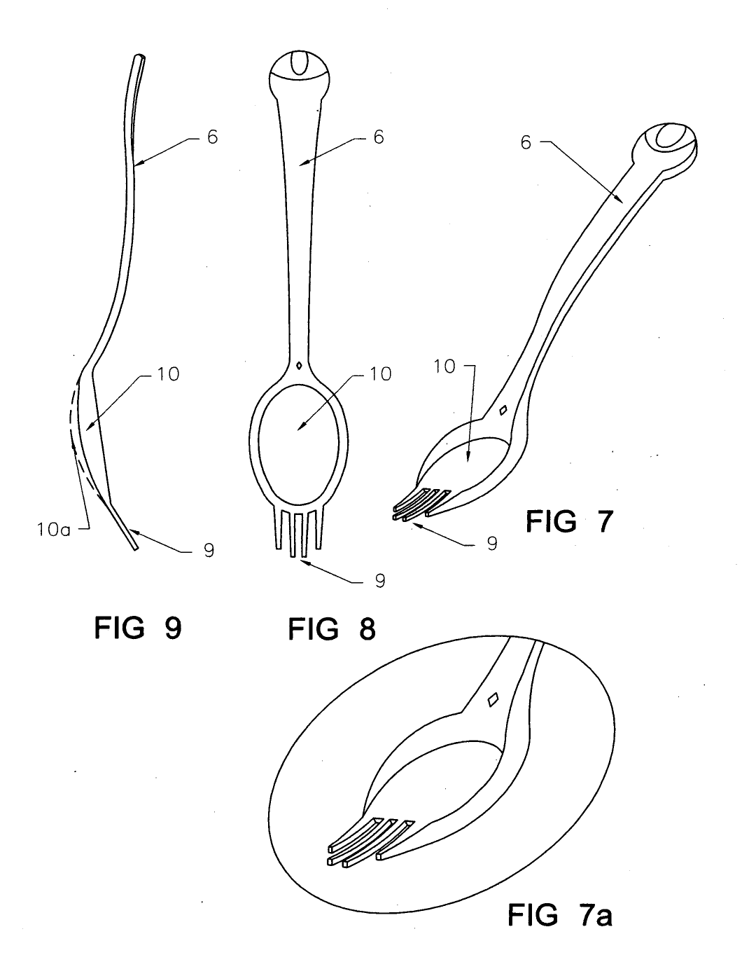

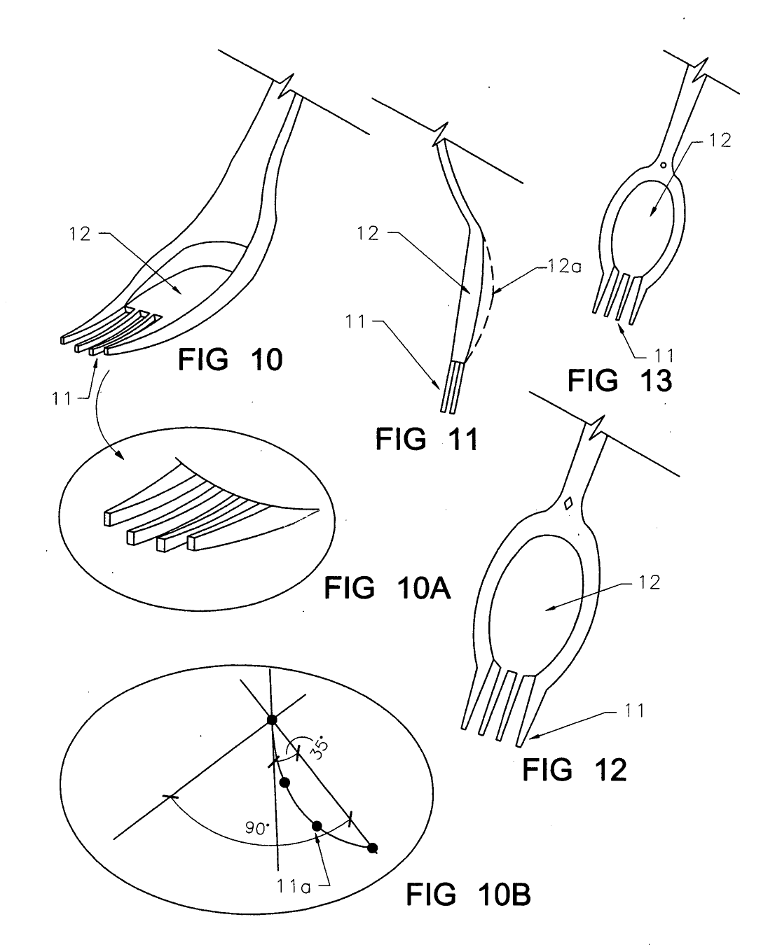

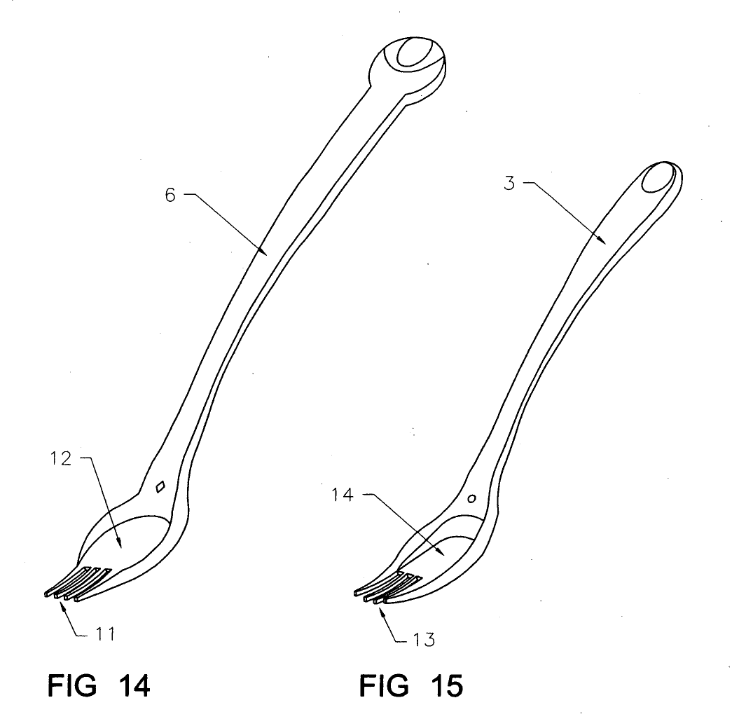

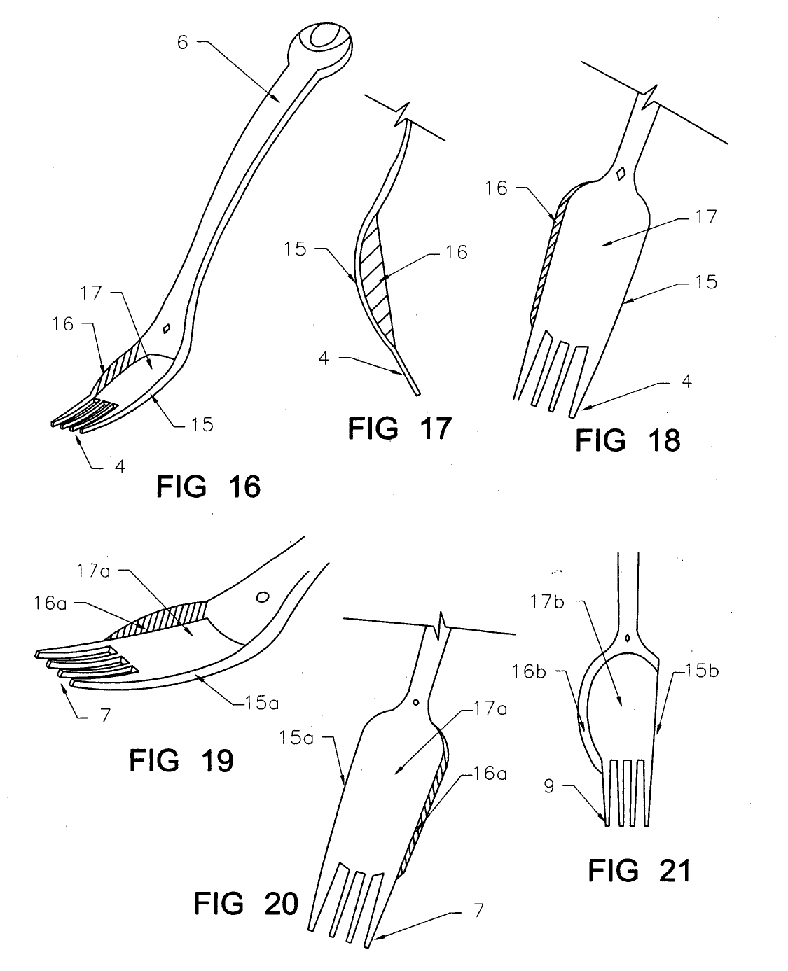

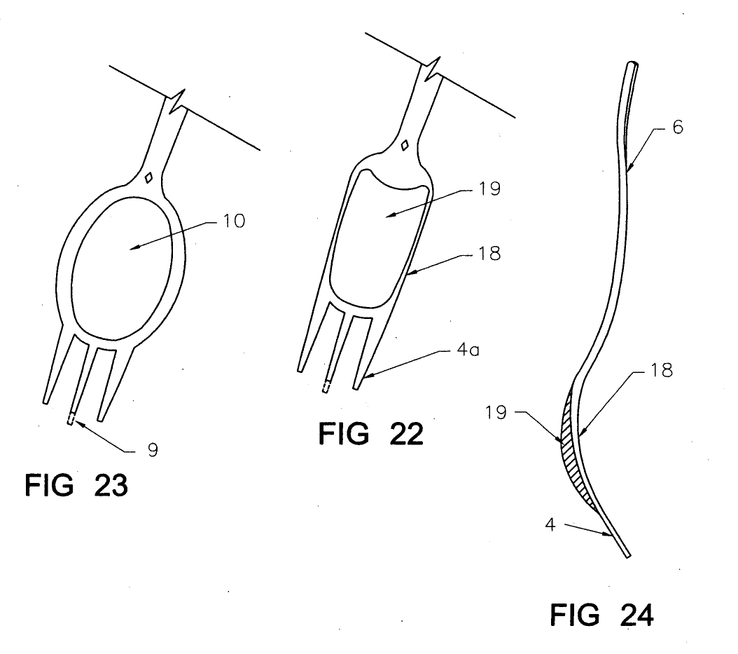

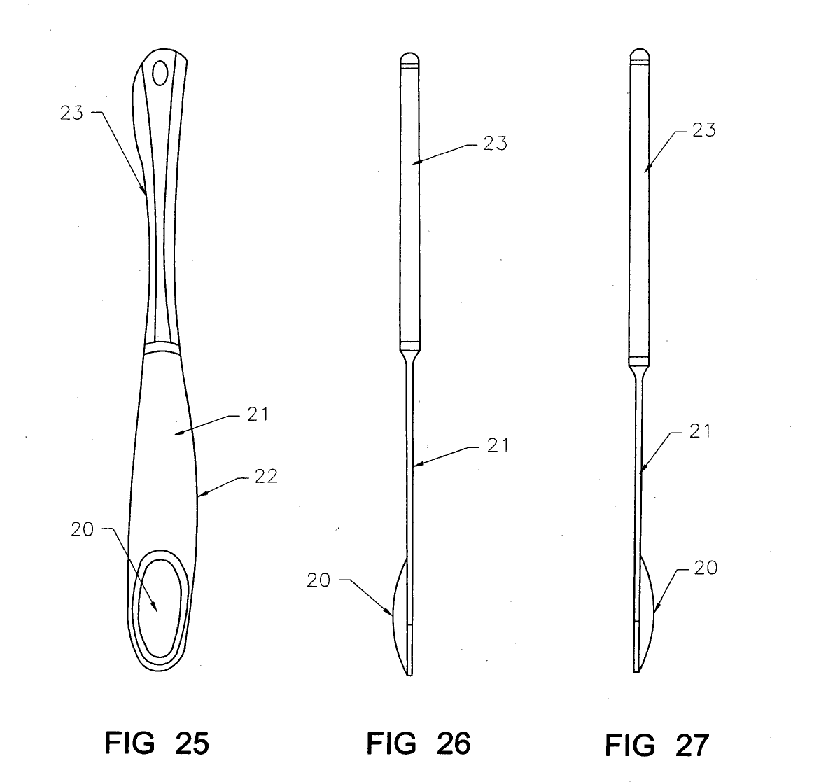

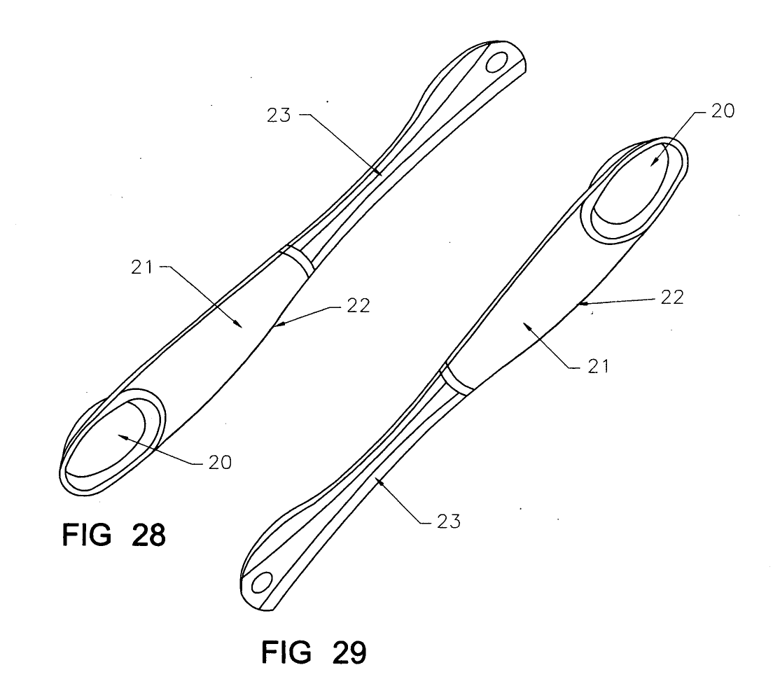

### V INDUSTRIAL APPLICATION

The manufacturing of this created spoon-fork and spoon-knife with dual functions termed as “two-in-one” flatware requires a little technology not different from the present technology in manufacturing the flatware. Therefore the manufacturing cost increased will be negligible, but the administration cost of the restaurants, food stores, and the catering business could be cut down by saving the usage of spoons in many circumstances.

With this invention, a table set of napkin, spoon-fork and knife could be appropriately provided for lunch and dinner in the restaurants.

The inconvenience caused by the present table set without a table spoon is solved. Alternatively, a table set could be included with an ordinary table fork with a created table spoon-knife with dual functions and save the table spoon. This arrangement of pairing is rational, practical, and economical. The guests will not feel embarrassed when a combo plate with rice, corn, and peas are served. The created small spoon-fork could be nicely used for serving salads. A complete set of table flatware could create a pleasant atmosphere for the dining guests.

This invented spoon-fork with different patterns and variations could be manufactured in plastic for appropriate and widely use in the fast food industries, the food stores, family parties, and social gathering events.

The present invention could have modifications and variations within the spirit of the prior art.

I make the following claims:

1. An innovative spoon-fork is created with four prongs and
a shallow bowl of oval shape or round shape or appropriate shape of spoon denting into the created fork as
a newly invented spoon-fork for dual functions, one as a spoon and another as a fork; two of the four piercing grills of the
said spoon-fork jetting out a little for firm piercing and holding of food, wherein the spoon either in oval shape, round shape, or any appropriate shape in discretion as variations of patterns for meeting the requirement of one flatware with dual functions.

2. A spoon-knife is created with
a dented bowl of an oval shape of
a teaspoon or any appropriate shape in line with the edge of the knife and making the table knife become
a spoon-knife with dual functions, one as a knife and another as a spoon.

3. A created spoon-fork with prongs and spoon for dual functions of claim 1 wherein the size of this invented flatware is in the size of a table fork or table spoon as Pattern I.

4. A created spoon-fork with prongs and spoon for dual functions of claim 1 wherein the size of this new flatware is in the sizes of a cake fork or teaspoon as Pattern Ia.

5. A created spoon-fork combined with prongs and spoon for dual functions of claim 1 wherein the two of the four piercing grills in the size of a table fork are jetted out a little for firm holding of food as Pattern II.

6. An invented spoon-fork for dual functions of claim 1 wherein the spoon-fork in rectangular shape creating from raising enclosures from any size of fork of which two of the four piercing grills are jetting out a little as Pattern IIa.

7. An invented spoon-fork with prongs and spoon for dual functions of claim 1 wherein the four piercing grills are in curve line around 35° between 1° and 90° and the spoon in the size of a table fork following the line making the shape of the table spoon-fork like a shovel as Pattern III.

8. A created spoon-fork for dual functions of claim 1 wherein the four piercing grills are in curve line around 35° between 1° and 90° and the spoon in the size of a cake fork following the line making the appearance of the spoon-fork like a shovel as Pattern IIIa.

9. An invented spoon-fork for dual function of claim 1, wherein the spoon is created from raising one side enclosure of a table fork or from a cake fork of which part of the space surrendering to the created spoon as Pattern IV.

10. An invented spoon-fork for dual functions according to claim 1 wherein the spoon is created from denting into one side of a table fork or from a cake fork with two of the four piercing grills jetting out a little for firm piercing and holding of food as Pattern V.

11. An invented spoon-fork combination for dual functions according to claim 1 wherein the spoon in any sizes creating from denting into the created fork at the left side of the created spoon-fork is for left handed diners as Pattern Va.

12. An invented spoon-fork for dual functions of claim 1 wherein the spoon is created by denting into the center of the existing space including part of the space of piercing grills of the size of table fork or dessert fork as Pattern VI.

13. An invented spoon-fork for dual functions of claim 1 wherein the spoon is created by denting into the center space including part of the space of piercing grills of the size of table spoon or dessert spoon with two of the four or one of the three piercing grills jetting out a little as variation Pattern VIa.

14. An invented spoon-knife with dual functions, one as a knife and another as a spoon of claim 2 wherein the shape of the dented bowl is in oval shape or alike as Pattern VII.

15. An invented spoon-knife with dual functions of claim 2 wherein the shape of the dented bowl is within the scope of the knife, in oval shape, round shape, narrow oval shape, or any shape appropriate to the knife as Pattern VIIa.

16. The created spoon-knife with dual functions of claim 2 wherein the created spoon bowl within the scope of the knife is a replica denting from opposite side for the use of left handed diners as Pattern VII b.

17. Irrespective of the shapes and sizes, any spoon-fork and spoon-knife created with dual functions is under the jurisdiction and prior art of this invention.
